(19) United States
(12) Patent Application Publication
(10) Pub. No.: US 2013/0231012 A1
(43) Pub. Date: Sep. 5, 2013

(54) Crimping Sleeve for Crimped Connections

(71) Applicants: Claude Lengert, Obernai (FR); Daniel Ackermann, Wittisheim (FR)

(72) Inventors: Claude Lengert, Obernai (FR); Daniel Ackermann, Wittisheim (FR)

(73) Assignee: STOCKO CONTACT GMBH & CO. KG, Wuppertal (DE)

(21) Appl. No.: 13/811,251

(22) PCT Filed: Jul. 14, 2011
(86) PCT No.: PCT/EP11/62033

§ 371 Date: May 1, 2013

(30) Foreign Application Priority Data
Jul. 19, 2010 (DE) 102010031505.2

(51) Int. Cl. H01R 4/20

(52) U.S. Cl. CPC H01R 4/20
USPC 439/877

(57) ABSTRACT

The invention relates to a crimping sleeve comprising a base part and at least two deformable crimping blades for producing a crimped connection to a cable, wherein the crimping blades each comprise a first region connected to the base part, a second region, and a middle region disposed between the first and the second regions, and wherein the base part comprises a greater thickness than the middle region of the crimping blades, the first region tapers down from the base part toward the middle region at least on a first side and the second region further tapers down from the middle region, starting at least on a second side opposite the first side, said sleeve thereby being equally suitable for cables having different cross sections for producing a reliable connection between the cables and crimping sleeve. The invention further relates to a connecting element having such a crimping sleeve.

### FIELD OF THE INVENTION

The invention relates to a crimp barrel and to a connecting element having such a crimp barrel.

### BACKGROUND OF THE INVENTION

Joining methods with which two components are mechanically connected to each other by means of plastic deformation are used, among other places, in electrical engineering. Such mechanical joining methods are also referred to as crimping and constitute an alternative to conventional connections such as soldering or welding. Crimping is used especially to create a homogeneous connection between a conductor and a connecting element that is difficult to undo and that ensures high electrical and mechanical reliability. The connecting element is often a plug with an appropriate crimp barrel. Wherever it is not easily possible to lay a wire that already has plugs, the wire alone is laid all the way to its destination site and only there is an electric contact part installed at the end of the conductor (for example, by crimping a plug onto it).

Crimping pliers (or a crimping tool) are used to non-positively connect the crimp barrel of the plug to the wire. These tools are usually operated by a toggle mechanism since manual force is not sufficient to achieve a permanent deformation of the crimp barrel. This connection technique has found widespread use, particularly in the realm of high-frequency electronics and telecommunications, since it offers not only connection reliability but also a considerable simplification in terms of handling. This procedure is carried out with special crimping pliers. Here, the tool and the compressive force of the crimping pliers have to be precisely adapted to the crimp barrel. A gas-tight connection is created when crimping is carried out properly. The deformation of the crimp barrel and of the small-gauge conductor gives rise to a structure that is largely shielded from oxygen and whose interior is thus largely protected against corrosion.

However, if insufficient force is applied during the crimping procedure or if the crimping tool used is too big, then the small-gauge conductors are inadequately compressed. In this case, oxygen can reach the individual small-gauge conductors. This brings about an increase in the transfer resistance between the conductor and the crimp barrel due to corrosion of the individual small-gauge conductors. Moreover, the risk exists that an incompletely compressed conductor can be pulled out of the crimp barrel. Furthermore, the cross sections of bulky and small-gauge conductors can be impermissibly reduced if the compression is excessive or if the crimping tool is too small. This can cause the current carrying capacity of the connection to be impermissibly diminished as a result of the reduced cross section. Moreover, if the compressive force is exceeded to an extreme extent, there is a risk that, in the case of small-gauge conductors, individual conductors might be sheared off. Furthermore, the crimp barrel can become unusable if it cracks or ruptures.

Therefore, when it comes to making a reliable crimped connection, crimping profiles that are precisely adapted to the crimp barrel and to the conductor cross section are used to achieve a precisely prescribed deformation of the crimp barrel and of the conductor. Document DE 10 200 004680 A discloses a crimp barrel whose shaping makes it possible to crimp conductors in the small cross section range from 0.08 mm² to 0.13 mm² Since the conductor cross sections can also be significantly larger (for example, 0.35 mm²), different crimp barrels and crimping tools that are suitable for these cross sections have to be kept on hand. Therefore, it would be desirable to put forward crimp barrels that are equally suited for wires with different cross sections and that can thus be applied by the same crimping tool.

### SUMMARY OF THE INVENTION

Consequently, it is the objective of the invention to put forward a crimp barrel that is equally suited for wires with different cross sections in order to make a reliable connection between the wire and the crimp barrel.

This objective is achieved by a crimp barrel comprising a base part and at least two deformable crimping wings in order to make a crimped connection with a wire, whereby the crimping wings each have a first zone connected to the base part, a second zone, and a middle zone situated between the first zone and the second zone, whereby the base part is thicker than the middle zone of the crimping wings, the first zone tapers from the base part towards the middle zone, at least on a first side, and the second zone tapers further starting from the middle zone, at least on a second side that is opposite from the first side.

The interaction of a relatively thick base part and crimping wings that are thinner according to the invention is decisive for the fact that this crimp barrel can yield a reliable crimped connection between the crimp barrel and the wire equally well for larger and for smaller wire cross sections. The base part has to have sufficient mass so that, after the crimped connection has been made, it can form a solid bottom for the connecting element with a strong connection between the crimp barrel and the wire. For this purpose, the base part can have a thickness of, for instance, 0.8 mm, which means, for example, that wires with cross sections between 0.35 mm² and 0.75 mm² can be reliably crimped with a crimp barrel according to the invention. The tapering in the thickness of the first zone of the crimping wings is necessary so that, on the one hand, there is still enough material in the side area of the crimped connection and so that, on the other hand, an optimal compacting of the conductor can be achieved by means of the ratio thus established between the height and width of the crimped connection. Here, the term “tapering” refers to the reduction in the thickness of the crimping wings, which can be uniform or non-uniform. The further tapering of the second zone allows the crimping wing to roll up in this zone when the crimped connection is made, resulting in a reliable crimped connection with a large material cross section that presses from above onto the wire and onto the bottom part situated underneath it (with the base part as a part of it). For example, the thickness of the middle zone can be between 0.4 mm and 0.5 mm In this context, the term “zone” refers to a section in the crimping wing having a certain length as seen perpendicular to the envisaged wire direction. As seen in a sectional side view, the tapering can have any suitable shape. It can be, for example, monotone or it can be provided with a contour (non-monotone). Examples of monotone tapering would be tapering along a circular arc or else linear tapering. Within the scope of the present invention, the person skilled in the art can also consider other tapering shapes.

Here, the term “crimped connection” refers to any form of connection that creates a mechanically strong connection through material deformation (crimping) of the barrel and of the object when a mechanical pressure is exerted onto an object surrounded by a barrel. When it comes to the crimping of wires, the surrounded object is the stripped wire, so that a good electrical contact with the crimp barrel can be established by means of the crimped connection. Here, the term “barrel” does not necessarily refer to a closed shape before the crimped connection is made. For example, before the crimped connection is made, the barrels can be open or closed barrels into which the stripped wire is laid or inserted. Open barrels are usually available with a pre-curved shape (crimp shape), so that the crimped connection can be easily made by means of an appropriately shaped tool. The crimp shape is preferably in the form of a “V”, with a rounded-off bottom, in which the base part and the first zones of the crimping wing form the base of the rounded-off V-shape. The completed crimped connection has a bottom and side area having an approximately rectangular cross section. The side on which, when the crimping tool is applied, the crimping wings touch each other, roll up and press on the wire situated underneath is referred to as the top of the crimped connection. Accordingly, the opposite side (bottom part) of the crimp barrel is referred to as the bottom. The parts between the bottom and the top are the above-mentioned side areas. The first side is defined as the side of the crimp barrel that completely faces the wire after the crimped connection has been made. Accordingly, the second side is the side of the crimp barrel that is opposite to the first side. The second side of the crimping wings refers to the side of the crimping wings that faces away from the wire, at least in the bottom area and in the side areas after the crimped connection has been made.

The crimp barrels according to the present invention, at least in the area of the base part and of the crimping wings, have to consist of readily deformable and electrically conductive material such as a copper alloy (for example, brass, bronze, copper, nickel silver), steel or aluminum alloys. The crimping wings can have, for example, a rectangular cross section as seen in the direction leading from the base part to the second zone. So that the electric current can be transmitted from the wire via the crimp barrel, for example, to an electric device, the crimp barrel is preferably part of a connecting element that is provided for purposes of connection to the electric device, and/or the crimp barrel is connected to the electric device via an electrically conductive path. Crimping tools are commercially available tools for making a crimped connection between a crimp barrel and an electric wire, for example, hand-held crimping tools.

The term “wire” here comprises all kinds of electric wires with suitable cross sections, for example, single-strand or multi-strand wires or else wires consisting of numerous fine flexible leads.

In one embodiment, the base part has a constant thickness in the uncurved state. This thickness can be, for instance, 0.8 mm Here, the base part has to have sufficient mass so that, after the crimped connection has been made, it can form a solid bottom for the connecting element, with a strong connection between the crimp barrel and the wire. A constant thickness of the base part is advantageous so that the base part, as the support area under the wire, has enough stability to withstand pressure while the crimped connection is being made. A constant thickness translates into a sturdy crimped bottom.

In one embodiment, the first zone tapers linearly in the uncurved state. In the present invention, the term “linear tapering” refers to a decrease in the thickness of the material as seen in a sectional side view along a straight line with a certain gradient. Non-linear tapering, on the other hand, would be tapering like a circular arc, e.g. This tapering provides sufficient material in the area of curvature adjoining the base part, so that the compressed volume of the wire in the crimp barrel has a height-to-width ratio that allows compacting of the conductor in the wire. The first zone is then on the crimped bottom in the crimped state, at least partially as a side area (where the crimping wings are at least not severely deformed). In this manner, a gas-tight crimped connection with good electrical contact and conductive properties can be made.

In an alternative embodiment, the first zone has at least a first sub-zone adjoining the base part and at least a second sub-zone adjoining the middle zone, whereby the tapering in the first and second sub-zones is of a different magnitude in the uncurved state. In this manner, in addition to the above-mentioned advantages (in the case of linear tapering), a curvature of the first side that is virtually like a circular arc is achieved in the crimp shape before the crimped connection is made. The wire can fit especially well into this virtually circular curved first side. For this purpose, the tapering is greater in the first sub-zone than in the second sub-zone, since the crimping wings are more markedly curved in the first sub-zone for making the crimp shape than in the second sub-zone. The term “more markedly” refers here to a linear tapering with a greater gradient. In this manner, a virtually circular curved first side can be easily made. For this purpose, in one embodiment, the first sub-zone adjoins the second sub-zone. For this purpose, in another embodiment, the tapering in the first and second sub-zones is configured linearly with a different gradient. Both of these embodiments can also be combined. If the tapering in the second sub-zone were to be more marked than in the first sub-zone, then it would hardly be possible to create a circular first side crimp shape in the form of a “V”, and the support for the wire that is to be crimped would not be as good, since there would be more room in which the wire could slip. The tapering between the base part and the middle zone should be as steep as possible so that the crimping wings are as long as possible in the crimped state. Consequently, this promotes an ideal crimping behavior.

In another embodiment, the lateral extension of the base part and of the crimping wings is adapted in such a way that, in the crimped state, a bottom part is made up of the base part and of the first sub-zones. Thus, with normal material thicknesses in the base part and with the tapering in the first sub-zone, even wires with very small cross sections can be reliably crimped. The term “lateral extension” refers to the extension in the direction that is perpendicular to the envisaged direction of the wire in the crimp barrel. This achieves a good stability of the crimp shape.

The tapering of the second zone can be, for example, monotone or it can be provided with a contour (non-monotone). An example of monotone tapering would be tapering along a circular arc. Within the scope of the present invention, the person skilled in the art can also consider other shapes for the tapering. In one embodiment, the second zones of the crimping wings taper linearly in the uncurved state. For example, the second zone tapers at a gradient of approximately 20° relative to the second side in the middle zone. When the crimping wings are in the uncurved state, the faces of the second zone are perpendicular to the second side of the first and second zones as well as of the base part. During the crimping (making the crimped connection), this linear tapering of the second zone on the second side causes the crimping wings to roll up in the shape of a spiral that, as a shared large surface, presses on the wire. This prevents the second zones of the crimping wings from being left behind as sharp front edges during the crimping that could then push through the wire and possibly shear off one or more wire strands. Since the second zones roll up to form a spiral, a reliable and strong crimped connection with the wire is made.

In another embodiment, the magnitude of the linear tapering of the second zones is adapted in such a way that the second sides of the second zone are essentially parallel to each other in the case of a crimp barrel with an open crimp shape in the form of a “V”. This facilitates the insertion into the crimping trough of the crimping tool, which leads to a good crimping process. The expression “essentially” includes all crimp shapes that differ by a few degrees from an exact parallelism of the crimping wings in the second zones.

In one embodiment, in the uncurved state, the middle zone tapers along the first side toward the second zone. Here, the crimping wing thickness is defined in such a way that the ratio of the material thickness to the cross sectional shape is similar to a standard crimp barrel. The part of the middle zone facing the first zone can have a thickness, for instance, of 0.5 mm, which tapers toward the second zone, for example, to 0.4 mm This tapering is preferably linear. In a preferred embodiment, the tapering of the middle zone of the first side extends likewise over the second zone as well. This further promotes the rolling up of the second zones during the crimping procedure.

In another embodiment, the second side of the crimping wings outside of the second zone and the bottom of the base part in the uncurved state form a flat surface. This is advantageous from a manufacturing standpoint (e.g. in a stamping process) during the production of the crimping wings. Since the deformations are easier to produce from above, it is advantageous if the bottom remains flat (planar).

The invention also relates to a connecting element with a crimp barrel according to the present invention. Preferably, such a connecting element also comprises at least one insulation crimp for securing a wire (with or without insulation) and a functional part that is in electrical contact with the crimp barrel. The insulation crimp protects the crimped connection between the wire and the crimp barrel against mechanical effects such as bending load, buckling load and tensile load as well as against vibrations, all of which only act on the insulation crimp in case of a good crimped connection. The insulation crimp can be made of any desired material that can be sufficiently deformed mechanically in order to create a proper crimped connection. Preferably, the insulation crimp is made of the same material as the crimp barrel. Especially preferably, the entire connecting element is made of the same electrically conductive material, for example, brass, bronze, copper, nickel silver or steel. Preferably, the functional part is a plug. This makes a good connection to the functional part possible.

### BRIEF DESCRIPTION OF THE FIGURES

These aspects as well as other aspects of the invention are shown in detail in the figures below.

FIG. 1 crimp barrel according to the state of the art in a pre-bent shape (crimp shape),

FIG. 2 crimp barrel according to the present invention in a pre-bent shape (crimp shape),

FIG. 3 crimp barrel according to the present invention in an uncurved shape,

FIG. 4 crimped connection between a crimp barrel and a wire according to the state of the art (a), and according to the present invention (b),

FIG. 5 embodiment of a connecting element according to the present invention.

### DETAILED DESCRIPTION OF THE EMBODIMENTS

FIG. 1 shows a crimp barrel (CF-SdT) in a pre-bent shape in a side view (sectional view perpendicular to the later wire direction in the crimped connection) according to the state of the art. The pre-bent shape (crimp shape CF) is in the form of a “V” with a curved base and crimping wings facing upward that are at a maximum distance BR1 from each other, namely, the width of the crimp shape CF. The radius of curvature R1 of the curved base is dimensioned in such a way that a wire 4 having a certain cross section can be laid into the curved base. In order to achieve a radius of curvature R1 that is suitable for the wire 4, the base has to have a thickness a1. The crimp barrel has a first side S1 that faces the wire when the crimped connection has been made, and a second side S2 that is the side of the crimp barrel that is opposite from S1. The tips of the crimping wings P have a thickness a2 that is smaller than the thickness a1, so that the crimping wings can roll up during the crimping procedure.

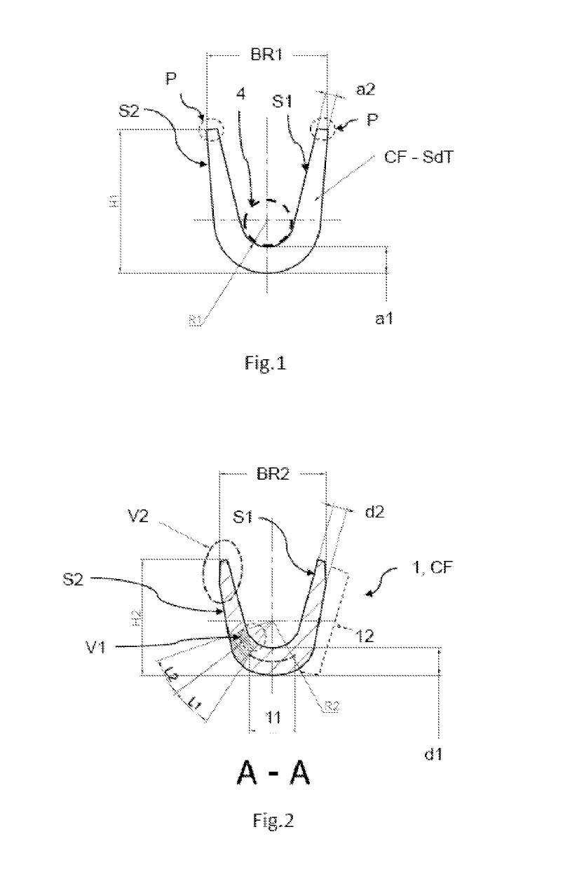

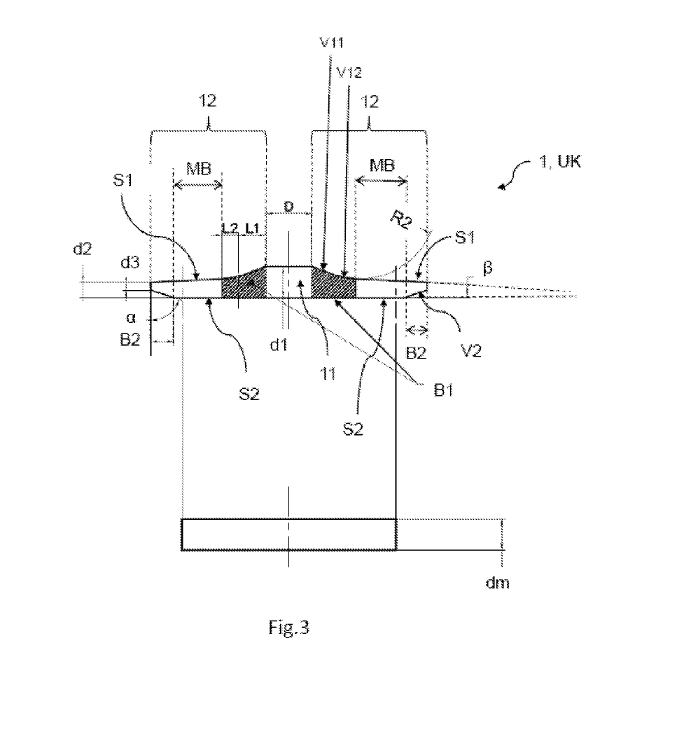

FIG. 2 shows a crimp barrel 1 in a pre-bent shape (crimp shape CF) in a sectional view along the direction A-A; in this context, also see FIG. 5. The pre-bent crimp shape CF is likewise in the form of a “V” with a curved base part 11 and crimping wings 12 facing upward that are at a maximum distance BR2 from each other, namely, the width of the crimp shape CF. The radius of curvature R2 of the curved base is dimensioned in such a way that a wire (not shown here for the sake of clarity) having a certain cross section can be laid into the curved base. In order to achieve a radius of curvature R2 that is suitable for the wire 4, the base has to have a thickness d1. The first zone of the crimping wings 12 adjoins the base part 11 and, as shown here, is divided into two sub-zones L1 and L2 (shown cross-hatched in the left-hand crimping wing). In alternative embodiments, instead of the sub-zones L1 and L2, the first zone could also be configured without being divided into sub-zones. The crimping wings 12 taper V1 markedly in the sub-zones L1 and L2, so that a suitable radius of curvature can be made for the individual wires having different cross sections. The crimp barrel 1 has a first side S1 that faces the wire when the crimped connection has been made, and a second side S2 that is the side of the crimp barrel 1 that is opposite from S1. The middle zone of the crimping wings 12 has a thickness d2 that is smaller than the thickness d1 and that tapers V2 further in the second zone of the crimping wings, so that the crimping wings 12 can roll up properly during the crimping procedure, even in case of wires with small cross sections.

FIG. 3 shows a crimp barrel in the uncurved state UK in a sectional view along the direction A-A; in this context, also see FIG. 5. The base part having a thickness d1 (e.g. 0.8 mm) and a lateral extension D (perpendicular to the later wire direction in the crimped connection) forms the central zone of the crimp barrel 1. In this embodiment, crimping wings 12, each consisting of a first zone B1, a middle zone MB and a second zone B2 adjoin the base part. The first zones B1 of the crimping wings 12 are connected to the base part 11 over the full length of the crimping wings 12 (in this context, see FIG. 5). The thickness of the crimping wings 12 tapers markedly in the first zone B1, which comprises two sub-zones L1, L2 (shown cross-hatched) in order to be able to make a crimped connection with a wire in a suitable shape in the later crimped connection. Here, the tapering V11 in the first sub-zone L1 is more pronounced (greater reduction of the thickness) than the tapering V12 in the second sub-zone L2. The middle zone MB of the crimping wings 12 having, for example, a thickness of 0.5 mm, then adjoins the first zone B1 at the boundary to the first zone B2. In this middle zone MB, the crimping wings 12 taper further, although not as markedly as in the first zone B1. An imaginary line that extend the first side S1 along the surface of the middle zone MB results in a tapering angle β with the imaginary line that extends side S2 which is flat in the base part 11, in the first zone and in the middle zone

BM (see broken lines). The second zone B2 has a first side S1 that, corresponding to the surface of the middle zone MB, likewise extends, i.e. with the same tapering angle, along the second zone B2 as well. The other opposite side S2 of the second zone B2 tapers V2 markedly toward the tip of the crimping wings 12. At the boundary to the middle zone MB, the second zone B2 has a thickness d2 (e.g. 0.4 mm) that is considerably larger than the thickness d3 (e.g. 0.15 mm) of the second zone B2 at its tip. In this example, the tapering V2 is configured in such a way that the second side S2 in the area of the second zone B2 encloses an angle of approximately 70° to the face of the second zone B2. This corresponds to an angle of approximately 20° between the two sides S2 in the middle zone MB and in the second zone B2. Furthermore, FIG. 3 shows a sectional view of the middle zone MB parallel to the base part 11. The middle zone MB has a rectangular shape along this section with a thickness dm which, however, depends on the place of the section. The closer the section is to the second zone B2, the smaller dm is. Directly at the boundary to the second zone B2, dm=d2. For example, d2=0.4 mm

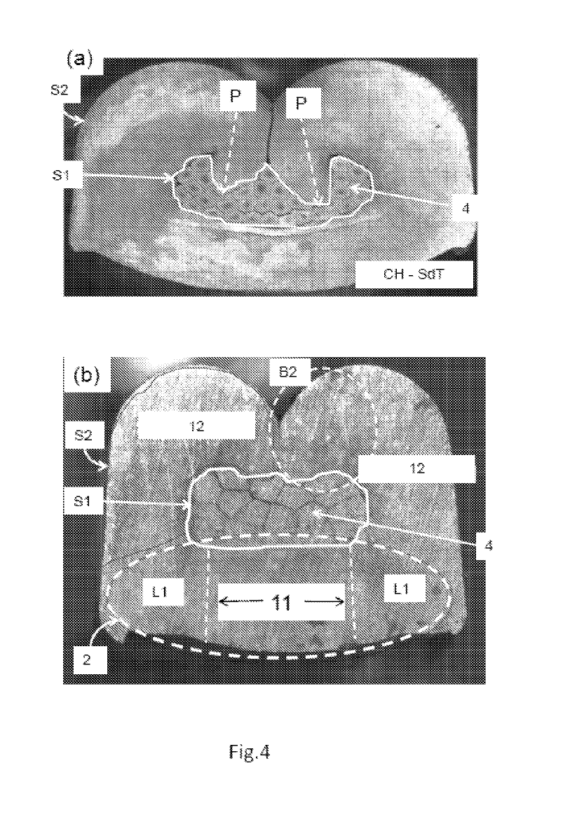

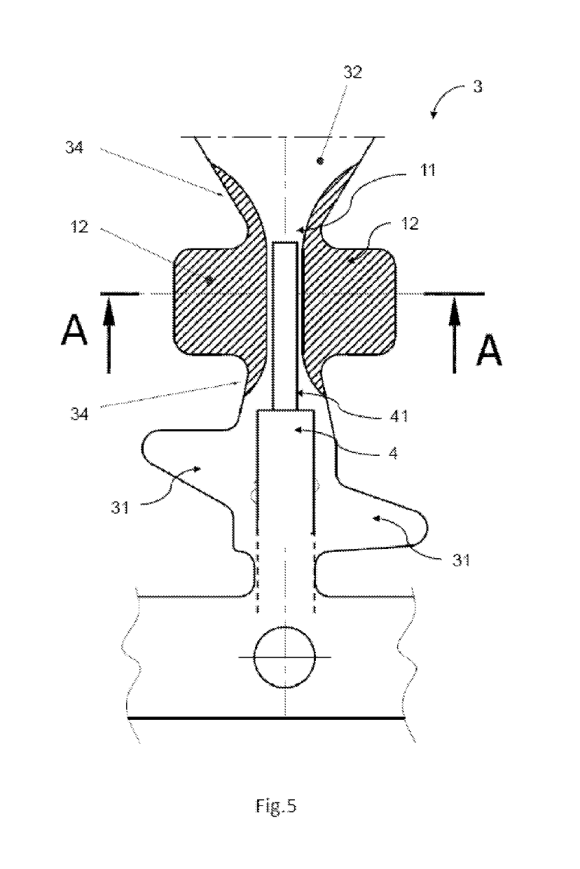

FIG. 4 shows crimp barrels with wires after a crimped connection has been made using an appropriate crimping tool for crimp barrels according to the state of the art (a), and according to the present invention (b). FIGS. 4(a) and 4(b) are not shown here true-to-scale relative to each other so that the size ratios from one figure cannot be transferred directly to the other figure. FIG. 4a shows that, with wires 4 having small cross sections, the crimp barrels according to the state of the art roll up in such a way that the tips P of the crimp barrels clearly penetrate the wire 4 and might even cut through the wire. On the one hand, this means that the crimp barrels are not securely fastened to the wire and, on the other hand, the conductivity of the wire is detrimentally affected. Conductor cross sections that are too small in the crimped state might lead to a reduced conductivity in this area. Moreover, the air exclusion of such a connection might no longer be ensured, so that, over the course of time, corrosion damage can occur at the crimped connection.

In contrast, FIG. 4b shows an ideal shape of a crimped connection with a crimp barrel according to the present invention, whereby the crimped wire has a smaller cross section that deviates from the ideal cross section. The bottom part 2 comprises the base part 11 (with a thickness of 0.8 mm) and the first sub-zone L1 of the two crimping wings 12. The side parts of the crimped connection are on the outer areas of the bottom part 2. At the top of the crimped connection, the crimping wings 12 easily roll up—thanks to their tapering according to the invention—into the second zones B2, but without any sharp edges protruding into the wire 4 (in contrast to the state of the art shown in FIG. 4a). The crimped wire 4 with its original cross section of 0.5 mm² has a rectangular cross section here with good holding and conducting properties. Only with a crimp barrel according to the present invention is this shape of the side S1 or of the wire, after completion of the crimped connection, possible over a wide range of wire cross sections.

FIG. 5 shows a connecting element 3 with a crimp barrel 1 in a top view (view of FIG. 2 from above). The sectional plane A-A, in which FIGS. 2 and 3 were shown, is indicated here by the line with the markings “A”. The crimping barrel has a base part 11 situated between the crimping wings 12. In this embodiment, the crimp barrel is part of the connecting element 3 that also comprises two insulation crimps 31 for holding the wire in the zone with intact wire insulation. The insulation crimps 31 are supposed to keep mechanical loads of the wire 4 away from the crimped connection with the stripped wire 41. The connecting element 3 also comprises a functional part 32 that is in electrical contact with the crimp barrel. This functional part 32 can be, for example, a plug for creating a connection to an electric device. The thicknesses of the crimping wings 12 are tapered relative to the base part 11, which is shown in FIG. 5 as a cross-hatched area. In order to better be able to make a crimped connection, this tapering can also extend in the direction of the insulation crimps 31 and of the functional part 32 (see zone 34), so that these parts are not exposed to excessive voltages after the crimped connection has been made. The crimp barrel or the entire connecting element can be made of the same electrically conductive material, for example, copper alloys (brass, bronze, copper, nickel silver, etc), steel or aluminum alloys.

The embodiments shown here are merely examples of the present invention and should not be construed in any limiting manner. Alternative embodiments considered by a person skilled in the art are likewise encompassed by the protective scope of the present invention.

### LIST OF REFERENCE NUMERALS

1 crimp barrel
11 base part
12 crimping wings
2 bottom part (=base part+first sub-zones)
3 connecting element
31 insulation crimp
32 functional part
4 wire
41 stripped part of the wire
B1 first zone of the crimping wing
L1 first sub-zone of the first zone
L2 second sub-zone of the first zone
B2 second zone of the crimping wing
MB middle zone of the crimping wing
S1 first side of the crimp barrel
S2 second side of the crimp barrel
V1 tapering in the first zone
V11 tapering in the first sub-zone of the first zone
V12 tapering in the second sub-zone of the first zone
V2 tapering in the second zone
UK crimp barrel in the uncurved state
CF crimp shape (crimp barrel in the pre-bent state)
CF-SdT crimp shape (crimp barrel in the pre-bent state) according to the state of the art
BR1 width of the crimp shape according to the state of the art
BR2 width of the crimp shape according to the present invention
H1 height of the crimp shape according to the state of the art
H2 height of the crimp shape according to the present invention
R1 radius of curvature of the curved crimp shape according to the state of the art
R2 radius of curvature of the curved crimp shape according to the present invention
P tip of the crimping wings according to the state of the art
D lateral extension of the base part
d1 thickness of the base part
d2 thickness of the second zone
d3 thickness of the tip of the second zone
dm thickness of the middle zone in the sectional view
a1 thickness of the base part according to the state of the art
a2 thickness of the tip of the crimp barrel according to the state of the art
α angle of tapering V2 in the second zone
β angle of tapering in the middle zone

1-15. (canceled)

16. A crimp barrel comprising a base part and at least two deformable crimp wings for producing a crimp connection with a cable, wherein the Crimp wing respectively connects a first portion with a base including a second portion and a central portion arranged between the first portion and the second portion, and wherein the base has a thickness greater than a thickness of the central portion, wherein the Crimp wing comprises a first area from the base part for the central portion down at least on a first side tapered, and a second area extending from the central portion, starting at least one of the first side opposite to the second side is further tapered.

17. The crimp barrel of claim 16, wherein the base part in an unbent state has a constant thickness.

18. The crimp barrel of claim 17, wherein the first portion in the unbent state is linearly tapered.

19. The crimp barrel of claim 17, wherein the first area comprises at least one first sub-portion adjacent to the base part and at least one second sub-portion adjacent to the central portion, wherein a taper varies in the first sub-portion and the second sub-portion, in the unbent state.

20. The crimp barrel of claim 19, wherein the first sub-area is disposed adjacent to the second sub-area.

21. The crimp barrel of claim 20, wherein a plurality of constrictions linearly in the first sub-portion and second sub-portion each comprise a different pitch.

22. The crimp barrel of claim 21, wherein a lateral extent of the base and the crimp wing is adjusted so that a bottom part is in a crimped state of the base part and the first sub-areas.

23. The crimp barrel of claim 16, wherein the second portion of the crimp wing in the unbent condition is linearly tapered.

24. The crimp barrel of claim 16, wherein a strength of linear tapers of the second portion is adapted so that the second side of the second portion in the crimp barrel in crimping an open are substantially parallel to each other.

25. The crimp barrel of claim 16, wherein the central portion in an unbent state along a first side to the second portion tapers.

26. The crimp barrel of claim 16, wherein a taper of the middle portion of a first side extends equally on the second portion.

27. The crimp barrel of claim 16, wherein a second side of the crimp wing form outside the second portion and an underside of the base in an unbent state comprises a flat surface.

28. The crimp barrel of claim 16 comprising a connecting element with the crimp barrel.

29. The crimp barrel of claim 28, wherein the connecting element comprises at least one insulation crimp for mounting of an isolated portion of a cable and a functional part in electrical contact with the crimp barrel covers.

30. The crimp barrel of claim 29, wherein the functional part comprises a plug.
